(19) United States
(12) Patent Application Publication
(10) Pub. No.: US 2020/0274176 A1
(43) Pub. Date: Aug. 27, 2020

(54) FUEL CELL SYSTEM AND CONTROL METHOD OF FUEL CELL SYSTEM

(71) Applicant: TOYOTA JIDOSHA KABUSHIKI KAISHA, Toyota-shi (JP)

(72) Inventors: Satoshi SHIOKAWA, Okazaki-shi (JP); Shinji ASO, Toyota-shi (JP)

(21) Appl. No.: 16/790,561

(22) Filed: Feb. 13, 2020

(30) Foreign Application Priority Data
Feb. 27, 2019 (JP) 2019-033995

(51) Int. Cl. H01M 8/04828; H01M 8/04746; H01M 8/04858; H01M 8/04225; H01M 8/04089; H01M 8/0438; H01M 8/0444

(52) U.S. Cl. CPC H01M 8/0494; H01M 8/04753; H01M 8/0491; H01M 8/04225; H01M 2250/20; H01M 8/04395; H01M 8/04455; H01M 8/0488; H01M 8/04089

(57) ABSTRACT

When electric power requested from a load exceeds a predetermined reference value, an operating state of the fuel cell system is controlled so as to enable a normal operation mode where the fuel cell generates electric power corresponding to the requested electric power. When the requested electric power is the reference value or less, the operating state is controlled to enable an intermittent operation mode. A refresh process for sweeping current from the fuel cell and lowering the voltage of the fuel cell to a reduction voltage is executed during a shift from the intermittent operation mode to the normal operation mode. The current swept from the fuel cell at the start of the refresh process is reduced more as an oxygen amount in the fuel cell at the end of the intermittent operation mode is smaller.

### INCORPORATION BY REFERENCE

The disclosure of Japanese Patent Application No. 2019-033995 filed on Feb. 27, 2019 including the specification, drawings and abstract is incorporated herein by reference in its entirety.

### BACKGROUND

### 1. Technical Field

The present disclosure relates to a fuel cell system and a control method of the fuel cell system.

### 2. Description of Related Art

In the process where a fuel cell continues electric power generation, the electric power generation causes formation of an oxide film on a catalyst that is included in a cathode of the fuel cell, which may result in deterioration in electric power generation performance. In order to recover the deteriorated electric power generation performance, there is known a method for executing a process (refresh process) for removing the oxide film by decreasing the voltage of the fuel cell to a reduction voltage in which the oxide film on the catalyst is reduced. International Publication WO 2013/128610 discloses a configuration for executing the refresh process during a shift from an operating state (what is called intermittent operation) where a load request in the fuel cell system is small and a power generation command value to a fuel cell is set to zero to an operating state (what is called normal operation) where the fuel cell generates electric power corresponding to the load request.

### SUMMARY

However, inventors of the present disclosure found out a new problem that when the refresh process is executed during a shift from the intermittent operation to the normal operation, the voltage of the fuel cell at the time of the refresh process may deviate and vary from a desired appropriate reduction voltage. When the voltage of the fuel cell during the refresh process becomes lower than the desired reduction voltage, it may cause an excessive reduction of a catalyst. Accordingly, there has been a demand for a technique that reduces variation in voltage of the fuel cell at the time of the refresh process and approximates the voltage of the fuel cell at the time of the refresh process to the desired reduction voltage.

The present disclosure can be implemented as the following aspects.

According to one aspect of the present disclosure, a fuel cell system is provided. The fuel cell system includes: a fuel cell; an oxidation gas supply unit; a control unit; and a determination unit. The fuel cell is formed of a stack of a plurality of single cells, the fuel cell being configured to supply electric power to a load upon receiving supply of an oxidation gas containing oxygen and a fuel gas containing hydrogen. The oxidation gas supply unit is configured to supply the oxidation gas to the fuel cell. The control unit is configured to control an operating state of the fuel cell system. The determination unit is configured to determine an oxygen amount in the fuel cell. When electric power requested from the load exceeds a predetermined reference value, the control unit controls the operating state of the fuel cell system so as to enable a normal operation mode where the fuel cell generates electric power corresponding to the requested electric power. When the requested electric power becomes the reference value or less, the control unit controls the operating state of the fuel cell system so as to enable an intermittent operation mode where the oxidation gas supply unit supplies to the fuel cell an oxygen amount that is required to adjust the voltage of the fuel cell to a preset target voltage, the oxygen amount being smaller than the oxygen amount supplied to the fuel cell in the normal operation mode. The control unit executes a refresh process for sweeping current from the fuel cell and thereby lowering the voltage of the fuel cell to a reduction voltage at timing when the intermittent operation mode ends during a shift from the intermittent operation mode to the normal operation mode. The control unit sets a value of the current swept from the fuel cell at the start of the refresh process to be smaller, as the oxygen amount determined by the determination unit at the timing is smaller.

The fuel cell system according to the aspect can restrain the voltage of the fuel cell from deviating and varying from the desired reduction voltage at the time of execution of the refresh process. This makes it possible to restrain an excessive reduction of the catalyst due to the voltage being too low at the time of the refresh process.

In the fuel cell system of the aspect, the determination unit may determine that the oxygen amount in the fuel cell is smaller as the voltage of the fuel cell at the timing is lower. The fuel cell system according to the aspect can determine the oxygen amount in the fuel cell with use of a voltage sensor typically included in the fuel cell system. Accordingly, it is not necessary to provide an additional sensor dedicated for acquisition of the oxygen amount, which can restrain complication of the system configuration.

In the fuel cell system of the aspect, the determination unit may determine that the oxygen amount in the fuel cell is smaller as a difference between a maximum value and a minimum value of respective voltages of the plurality of single cells that configure the fuel cell at the timing is larger. The fuel cell system according to the aspect can determine the oxygen amount in the fuel cell with use of a voltage sensor typically included in the fuel cell system. Accordingly, it is not necessary to provide an additional sensor dedicated for acquisition of the oxygen amount, which can restrain complication of the system configuration.

In the fuel cell system of the aspect, the determination unit may determine that the oxygen amount in the fuel cell is smaller as a minimum value of respective voltages of the plurality of single cells that configure the fuel cell at the timing is smaller. The fuel cell system according to the aspect can determine the oxygen amount in the fuel cell with use of a voltage sensor typically included in the fuel cell system. Accordingly, it is not necessary to provide an additional sensor dedicated for acquisition of the oxygen amount, which can restrain complication of the system configuration.

The present disclosure can be implemented in various aspects other than the aspects disclosed above. For example, the present disclosure can be implemented in such aspects as a mobile object mounted with a fuel cell system as a power source for driving, a method of removing an oxide film on a cathode of a fuel cell, a control method of a fuel cell system including a fuel cell, a computer program that implements such a control method, and a non-transitory recording medium that records the computer program.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing a schematic configuration of a fuel cell vehicle;

FIG. 2 is a flowchart showing a refresh process routine;

FIG. 3 is an explanatory view showing the state before and after the refresh process is performed;

FIG. 4 is an explanatory view showing a relation between IV characteristics of the fuel cell and the flow rate of oxidation gas; and

FIG. 5 is an explanatory view showing the state before and after the refresh process in a comparative example.

### DETAILED DESCRIPTION OF EMBODIMENTS

### A. First Embodiment

A-1 Outline of Fuel Cell System:

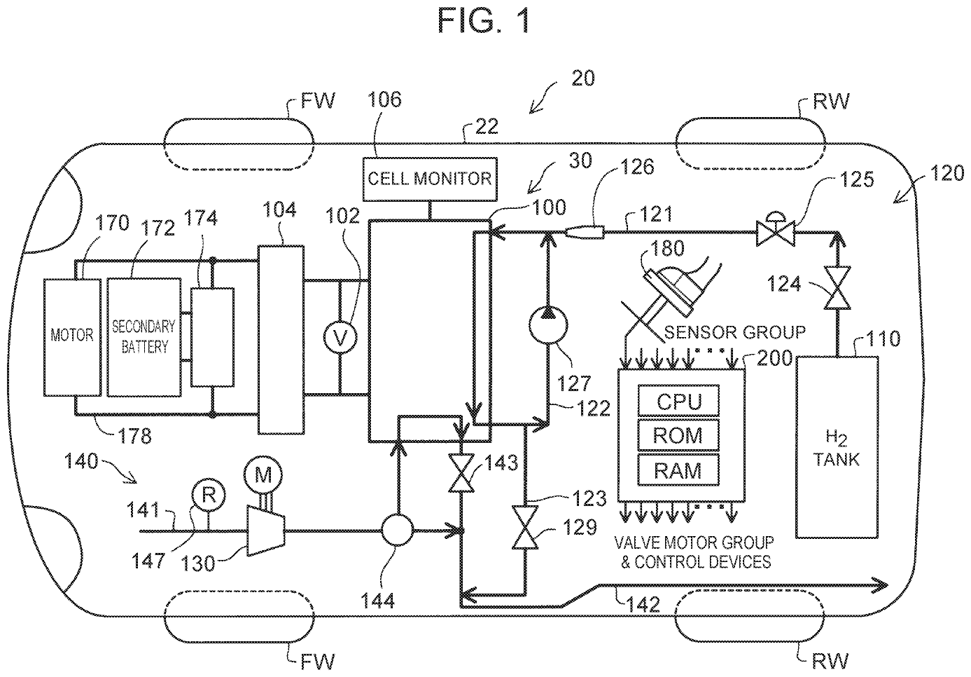

FIG. 1 is a block diagram showing the schematic configuration of a fuel cell vehicle 20 as an embodiment of the present disclosure. The fuel cell vehicle 20 has a fuel cell system 30 mounted on a vehicle body 22. The fuel cell system 30 and a drive motor 170 of the fuel cell vehicle 20 are connected by a wire 178. Through the wire 178, electric power is exchanged between the fuel cell system 30 and the drive motor 170.

The fuel cell system 30 includes a fuel cell 100, a fuel gas supply unit 120 including a hydrogen tank 110, an oxidation gas supply unit 140 including a compressor 130, a secondary battery 172, a DC-DC converter 104, a DC-DC converter 174, and a control unit 200. The fuel cell system 30 further includes an unillustrated coolant circulation unit for allowing a coolant for cooling the fuel cell 100 to flow inside the fuel cell 100. The fuel cell system 30 also allows the fuel cell 100 and the secondary battery 172 to supply electric power independently of each other or to simultaneously supply electric power to a load including the drive motor 170.

The fuel cell 100 has a stack constitution formed of a stack of a plurality of single cells. The fuel cell 100 of the present embodiment is a solid polymer electrolyte fuel cell. In each of the single cells which configure the fuel cell 100, a passage for carrying hydrogen to the anode side (henceforth also called an anode-side passage), and a passage for carrying oxygen to the cathode side (henceforth also called a cathode-side passage) are formed with an electrolyte membrane interposed therebetween. The fuel cell 100 is connected to the load including the drive motor 170 through the DC-DC converter 104 and the wire 178. A current sensor 101 detects an output current of the fuel cell 100, and a voltage sensor 102 detects an output voltage of the fuel cell 100. A cell monitor 106 detects voltages of the single cells which configure the fuel cell 100. Detection signals from the current sensor 101, the voltage sensor 102, and the cell monitor 106 are output to the control unit 200.

The DC-DC converter 104 has a function of changing an output state of the fuel cell 100 upon reception of a control signal of the control unit 200. Specifically, the DC-DC converter 104 takes out current and voltage that flows from the fuel cell 100 to the load, and controls the current and voltage taken out from the fuel cell 100 through switching control in the DC-DC converter 104. When supplying the electric power generated by the fuel cell 100 to the load such as the drive motor 170, the DC-DC converter 104 boosts the output voltage of the fuel cell 100 to a voltage usable in the load.

The hydrogen tank 110 included in the fuel gas supply unit 120 is a device that reserves a fuel gas containing hydrogen. Specifically, the hydrogen tank 110 may be defined, for example, as a tank for reserving high-pressure hydrogen gas, or as a tank including a hydrogen storage alloy that stores hydrogen so as to reserve the stored hydrogen. The fuel gas supply unit 120 includes a hydrogen supply passage 121 extending from the hydrogen tank 110 to the fuel cell 100, a circulation passage 122 for circulating an anode offgas to the hydrogen supply passage 121, and a hydrogen release passage 123 for releasing the anode offgas to the atmosphere. In the fuel gas supply unit 120, the hydrogen gas reserved in the hydrogen tank 110 passes through a switching valve 124 and a reducing valve 125 in the hydrogen supply passage 121, and is then supplied to the anode-side passage of the fuel cell 100 from an injector 126 on the downstream side of the reducing valve 125. The pressure of the hydrogen that circulates through the circulation passage 122 is regulated by a circulation pump 127. The control unit 200 regulates driving amounts of the injector 126 and the circulation pump 127 in accordance with a target power generation amount of the fuel cell 100.

Some of the hydrogen gas flowing through the circulation passage 122 passes through a switching valve 129, provided in the hydrogen release passage 123 that branches from the circulation passage 122 so as to control a switching condition, and is then released to the atmosphere. This makes it possible to discharge impurities (such as vapor and nitrogen) other than hydrogen in the hydrogen gas flowing in the circulation passage 122, and to thereby restrain increase in concentration of impurities in the hydrogen gas that is supplied to the fuel cell 100. The control unit 200 regulates switching timing of the switching valve 129.

The oxidation gas supply unit 140 supplies an oxidation gas (air in the present embodiment) containing oxygen to the fuel cell 100. The oxidation gas supply unit 140 includes an air passage 141 and an air release passage 142 in addition to the compressor 130. With the air passage 141, the air taken in by the compressor 130 is supplied to the cathode-side passage in the fuel cell 100. The air passage 141 is equipped with a flow sensor 147. The flow sensor 147 detects a total flow of air taken in through the air passage 141. The cathode offgas discharged from the fuel cell 100 is released to the atmosphere through the air release passage 142. The air release passage 142 is connected to the hydrogen release passage 123. The hydrogen released through the hydrogen release passage 123 is diluted with air that flows through the air release passage 142 prior to be released to the atmosphere. The control unit 200 regulates the driving amount of the compressor 130.

The secondary battery 172 is connected to the wire 178 through the DC-DC converter 174. The DC-DC converter 174 and the DC-DC converter 104 are connected in parallel to the wire 178. As the secondary battery 172, various electric storage devices, such as a lead storage battery, a nickel-hydrogen battery, and a lithium ion battery, are adoptable. The DC-DC converter 174 has a charge and discharge control function for controlling charge and discharge of the secondary battery 172. Upon reception of a control signal of the control unit 200, the DC-DC converter 174 controls the charge and discharge of the secondary battery 172. In addition, when a target voltage on the output side is set under control of the control unit 200, the DC-DC converter 174 draws electric power preserved in the secondary battery 172, and applies voltage to the drive motor 170 so as to variably regulate an electric power drawing state and a voltage level applied to the drive motor 170.

The control unit 200 is formed of what is called a microcomputer including devices such as a CPU which executes logical operation, a ROM, and a RAM. The control unit 200 acquires detection signals from the sensors included in the fuel gas supply unit 120 and the oxidation gas supply unit 140, as well as from various sensors, such as an accelerator operation amount sensor 180, a shift position sensor, a vehicle speed sensor, and an ambient temperature sensor, and performs various control relating to the fuel cell vehicle 20. For example, the control unit 200 calculates the magnitude of a request output requested to the drive motor 170, based on the detection signal of the accelerator operation amount sensor 180, or the like, and outputs a drive signal to the respective units such that the electric power corresponding to the request output can be obtained from at least one of the fuel cell 100 and the secondary battery 172. Specifically, in the case of obtaining electric power from the fuel cell 100, the control unit 200 controls a gas supply amount from the fuel gas supply unit 120 or the oxidation gas supply unit 140 such that desired electric power can be obtained from the fuel cell 100. The control unit 200 also controls the DC-DC converters 104, 174 such that the requested electric power is supplied to the load such as the drive motor 170 from at least one of the fuel cell 100 and the secondary batteries 172.

In FIG. 1, the control unit 200 controls the entire fuel cell vehicle 20. However, different configurations may also be adopted. For example, a plurality of control units, such as a control unit for controlling the fuel cell system 30, a control unit relating to travel of the fuel cell vehicle 20, and a control unit for controlling vehicle accessories irrelevant to travel, may be provided, and necessary information may be exchanged among these control units.

A-2 Operation Mode and Refresh Process:

In the fuel cell vehicle 20 of the present embodiment, a plurality of operation modes including a normal operation mode and an intermittent operation mode are switched during operation of the fuel cell system 30. The normal operation mode is an operation mode selected when the electric power requested from the load to the fuel cell system 30 exceeds a predetermined reference value. In the normal operation mode, the fuel cell 100 generates electric power corresponding to the requested electric power of the load including the drive motor 170. In the normal operation mode, the secondary battery 172 may output at least some of the electric power requested from the load. The intermittent operation mode is an operation mode selected when the electric power requested from the load to the fuel cell system 30 becomes a preset reference value or less. In the intermittent operation mode in the present embodiment, the oxidation gas supply unit 140 supplies to the fuel cell 100 an oxygen amount that is required to adjust the voltage of the fuel cell 100 to a preset target voltage, the oxygen amount being smaller than the oxygen amount supplied to the fuel cell 100 in the normal operation mode. In the present embodiment, an output current of the fuel cell 100 is zero in the intermittent operation mode. In the present embodiment, when the requested electric power of the drive motor 170 is zero (when the accelerator is turned off, for example), the intermittent operation mode is asserted.

The fuel cell system 30 of the present embodiment executes a refresh process while starting electric power generation in the fuel cell 100 at timing when the intermittent operation mode ends during a shift from the intermittent operation mode to the normal operation mode. The refresh process is for sweeping current from the fuel cell 100 and thereby lowering the output voltage of the fuel cell 100 to a reduction voltage in which an oxide film formed on the cathode of each of the single cells which configure the fuel cell 100 is reduced. When the output voltage of the fuel cell 100 becomes an oxidation voltage (when the potential of the cathode becomes an oxidation potential), an oxide film is formed on a catalyst included in the cathode. When the output voltage of the fuel cell 100 becomes a reduction voltage (when the potential of the cathode becomes a reduction potential), the oxide film is reduced and is thereby removed from the top of the cathode. When the oxide film is formed on the cathode, an effective area of the catalyst decreases, which may result in deterioration in electric power generation performance. Accordingly, the fuel cell system 30 of the present embodiment performs the refresh process, in which current is swept from the fuel cell 100 and thereby the output voltage of the fuel cell is forcibly lowered so as to remove the oxide film on the cathode.

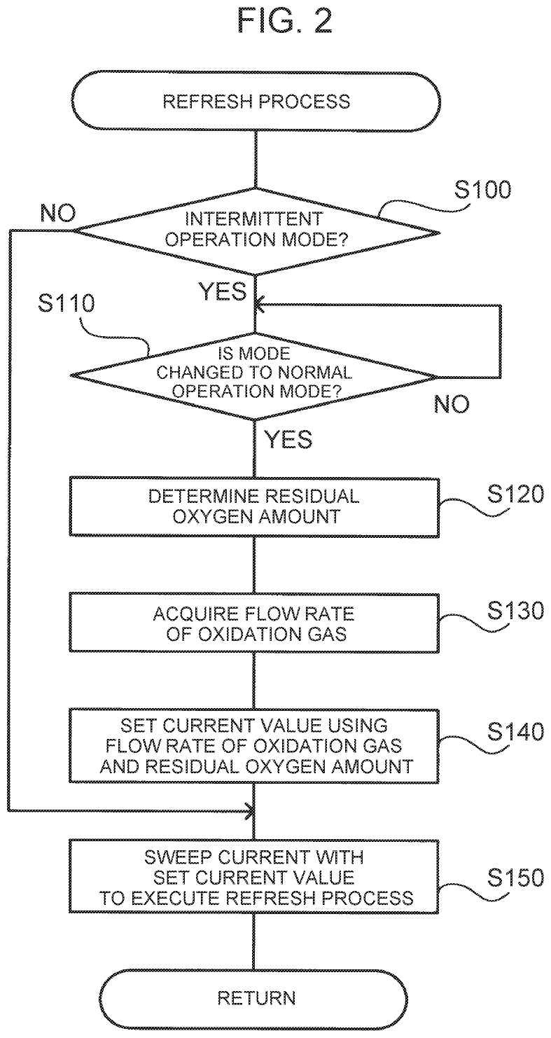

FIG. 2 is a flowchart showing a refresh process routine executed in the CPU of the control unit 200. The present routine is repeatedly executed during operation of the fuel cell system 30, that is, after the fuel cell system 30 is started until a user inputs an operation for stopping the system.

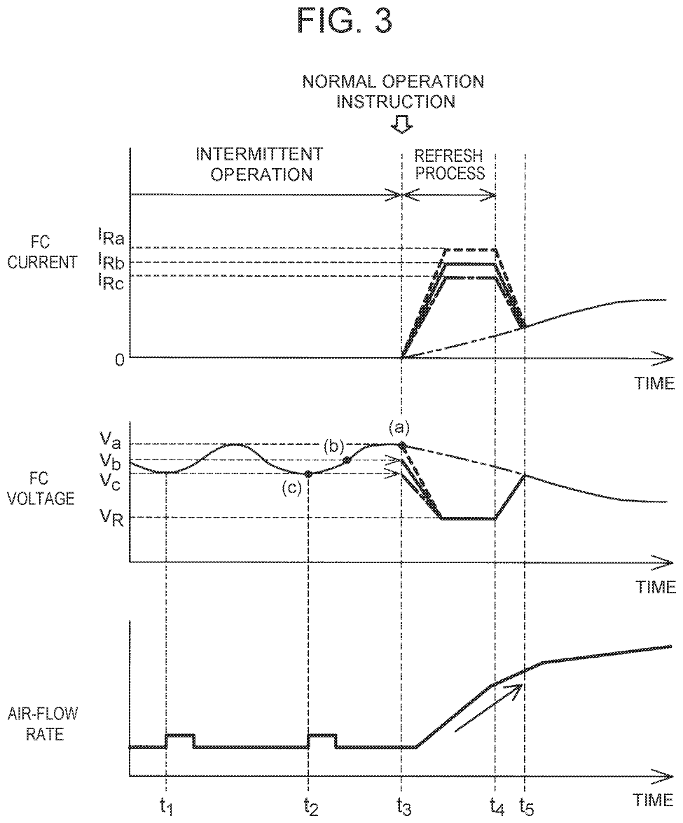

FIG. 3 is an explanatory view showing a relation among an output current (a total current of the fuel cell 100, which is also called an FC current) of the fuel cell 100, a voltage (a total voltage of the fuel cell 100, which is also called an FC voltage) of the fuel cell 100, and a flow rate (also called an air-flow rate) of the oxidation gas supplied to the fuel cell 100 before and after the refresh process is performed in the fuel cell system 30 of the present embodiment. In FIG. 3, a horizontal axis represents time. In the present embodiment, as described before, the refresh process is executed at timing when the intermittent operation mode ends in a shift from the intermittent operation mode to the normal operation mode. The value of current swept from the fuel cell 100 at the start of the refresh process is changed in accordance with the oxygen amount (hereinafter also called a residual oxygen amount) in the fuel cell 100 at the end of the intermittent operation mode. Hereinafter, the refresh process executed by the fuel cell system 30 will be described with reference to FIGS. 2 and 3.

When the refresh process routine of FIG. 2 is started, the control unit 200 determines whether or not the operating state of the fuel cell system 30 is the intermittent operation mode (step S100). When the operating state of the fuel cell system 30 is not the intermittent operation mode, (step S100: NO), the control unit 200 ends the present routine.

Hereinafter, the intermittent operation mode will be described in more detail. As described in the foregoing, in the present embodiment, the output current of the fuel cell 100 is zero in the intermittent operation mode. At the time, electric connection between the fuel cell 100 and the load such as the drive motor 170 is interrupted. As shown in FIG. 3, in the intermittent operation mode, the voltage of the fuel cell 100 is maintained between a voltage Va and a voltage Vc that is lower than the voltage Va. When the fuel cell 100 shifts from a power generation state to a stopped state, i.e., when connection between the fuel cell 100 and the load is interrupted and thereby the current output is set to zero in the state where hydrogen and oxygen sufficient (excessive) for electric power generation is supplied to the fuel cell 100, the fuel cell 100 generally demonstrates an extremely high open-circuit voltage (hereinafter, also called as OCV in the normal operation mode). This indicates that the cathode of the fuel cell 100 gains a very high electrode potential. In such a state, degradation in electrode catalyst and deterioration in battery performance may occur. Accordingly, in the present embodiment, in order to suppress deterioration in performance of the fuel cell 100, the oxygen amount supplied to the cathode-side passage is controlled in the intermittent operation mode that involves stop of electric power generation, by which the open-circuit voltage (hereinafter, also called an OCV in the intermittent operation mode) of the intermittent operation mode is kept in the aforementioned desired range (between the voltage Va and the voltage Vc) that is lower than the OCV in the normal operation mode.

In the present embodiment, even in the intermittent operation mode, the circulation pump 127 continues to be driven. Therefore, a sufficient amount of hydrogen is secured in the anode-side passage. Thus, when electric power generation of the fuel cell 100 and supply of oxidation gas thereto are stopped in the state where hydrogen is present in the anode-side passage, hydrogen permeates from the anode-side passage to the cathode-side passage through an electrolyte membrane in each of the single cells, and an oxidation reaction of permeated hydrogen proceeds in the cathode. As a result, oxygen in the cathode-side passage is consumed due to the oxidation reaction of the hydrogen which permeated the electrolyte membrane, resulting in decrease in OCV in the intermittent operation mode. In the present embodiment, as shown in FIG. 3, oxidation gas is intermittently supplied to prevent the OCV in the intermittent operation mode from lowering below the voltage Vc that is a lower limit, and the flow rate of the oxidation gas to be supplied is restrained such that the OCV in the intermittent operation mode does not exceed the voltage Va that is an upper limit. FIG. 3 shows an example where a fixed amount of air is supplied for a fixed period of time at time t1 and time t2 when the FC voltage lowers to the voltage Vc.

The voltage Va that is the upper limit and the voltage Vc that is the lower limit of the OCV in the intermittent operation mode may be set to proper values. For example, from a viewpoint of restraining degradation (dissolution) of the electrode catalyst attributed to a high potential, the voltage Va that is the upper limit of the OCV in the intermittent operation mode is desirably set to 0.9 V or less based on an average cell voltage, more desirably set to 0.85 V or less, and is still more desirably set to 0.8 V or less. In order to prevent the electrode catalyst of the cathode from being put in an excessive reduction state, it is desirable that the voltage of each cell does not lower to 0 V. Therefore, the voltage Vc that is the lower limit of the OCV in the intermittent operation mode is desirably set to 0.1 V or more based on the average cell voltage, and is more desirably set to 0.2 V or more. In order to secure responsiveness when the intermittent operation shifts to the normal operation mode, and electric power generation starts, the FC voltage in the intermittent operation mode is desirably higher. Accordingly, from a viewpoint of securing the responsiveness, the voltage Vc that is the lower limit of the OCV in the intermittent operation mode is desirably set to, for example, 0.6 V or more based on the average cell voltage, and is more desirably set to 0.7 V or more.

In the above description, oxidation gas is intermittently supplied in the intermittent operation mode. However, different configurations may be adopted. For example, a small amount of oxidation gas may constantly be supplied to the fuel cell 100. As described in the foregoing, when electric power generation stops, hydrogen permeates from the anode-side passage to the cathode-side passage, and oxygen in the cathode-side passage is consumed. Therefore, an extremely small amount of oxidation gas, corresponding to the amount of oxygen consumed due to such permeated hydrogen, may continuously be supplied to the fuel cell 100, for example. In this case, the amount of oxidation gas supplied to the fuel cell 100 may further be regulated by performing feedback control using a detection value of the voltage sensor 102 so as to prevent the OCV in the intermittent operation mode from deviating from the range between the upper limit Va and the lower limit Vc. Hence, it can be said that the intermittent operation mode is an operation mode where the flow rate of the oxidation gas supplied to the fuel cell 100 is kept considerably lower than that in the normal operation mode.

The amount of oxidation gas supplied to the fuel cell 100 is determined by a driving amount of the compressor 130, an opened state of the flow dividing valve 144, and an opening degree of the backpressure valve 143. In the present embodiment, among these parameters, the driving amount of the compressor 130, and the opened state of the flow dividing valve 144 are fixed, while the opening degree of the backpressure valve 143 is variable so as to control such that the OCV in the intermittent operation mode falls within the above-stated range in the intermittent operation mode.

Referring again to FIG. 2, when the operating state of the fuel cell system 30 is the intermittent operation mode, (step S100: YES), the control unit 200 determines whether or not an instruction for changing to the normal operation mode is input (step S110). In step S110, when, for example, the accelerator operation amount sensor 180 detects accelerator operation, the control unit 200 can determine that an instruction for starting the normal operation mode is input. The control unit 200 repeats the determination of step S110 until the instruction for changing to the normal operation mode is determined to be input.

When determining that the instruction for changing to the normal operation mode is input in step S110 (step S110: YES), the control unit 200 determines the residual oxygen amount in the fuel cell 100, i.e., the residual oxygen amount that is the amount of oxygen remaining inside the fuel cell 100 at the end of the intermittent operation mode (step S120). In the present embodiment, the control unit 200 determines that the residual oxygen amount in the fuel cell 100 is smaller, as the voltage of the fuel cell 100 at the end of the intermittent operation mode, i.e., the voltage immediately before the fuel cell 100 starts electric power generation after the intermittent operation mode ends, is lower. This is because in the intermittent operation mode, the voltage of the fuel cell 100 lowers because oxygen in the cathode-side passage is consumed by the reaction with the hydrogen which permeated the electrolyte membrane as described before. In step S120, the control unit 200 functions as a determination unit that determines the oxygen amount in the fuel cell 100.

Then, the control unit 200 acquires the flow rate of the oxidation gas supplied to the fuel cell 100 (step S130). When the instruction for changing to the normal operation mode is input, the compressor 130 is driven to start supply of oxidation gas, even in the case where the oxidation gas is not supplied to the fuel cell 100 at the end of the intermittent operation mode. The flow rate of the oxidation gas to be supplied to the fuel cell 100 can be set to, for example, a detection value of the flow sensor 147. Alternatively, the flow rate of the oxidation gas supplied to the fuel cell 100 may be calculated based on the driving amount of the compressor 130. Alternatively, since a small amount of oxidation gas is supplied immediately after the start of the refresh process, a value predetermined as an initial value of the supply amount of oxidation gas is stored in the control unit 200 in advance, and the stored initial value may be acquired in step S130.

With use of the flow rate of the oxidation gas acquired in step S130 and the residual oxygen amount determined in step S120, the control unit 200 sets a value of current to be swept from the fuel cell 100 at the start of the refresh process (step S140).

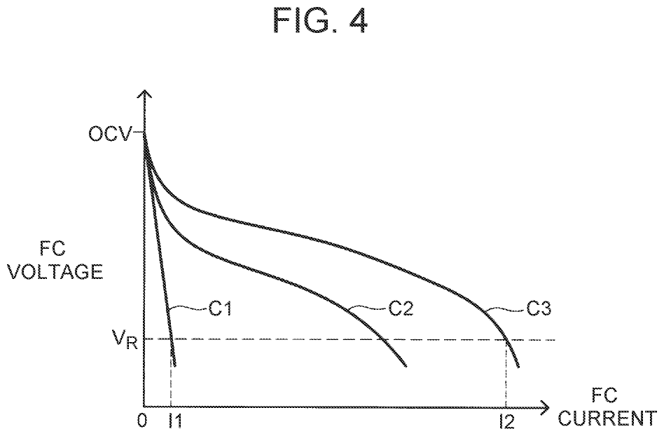

FIG. 4 is an explanatory view showing a relation between IV characteristics (current-voltage characteristics) of the fuel cell 100 and the flow rate of oxidation gas (air) supplied to the fuel cell 100. Described below with reference to FIGS. 3 and 4 is a value of current swept from the fuel cell 100 at the start of the refresh process, the value being set in step S140. In FIG. 4, a horizontal axis represents an output current of the fuel cell 100, and a vertical axis represents an output voltage of the fuel cell 100. FIG. 4 shows three graphs C1 to C3 which express the IV characteristics of the fuel cell 100 in three cases which are different in flow rate of the oxidation gas supplied to the fuel cell 100. The graph C1 shows the case where the flow rate of the oxidation gas to be supplied is the smallest, and the graph C3 shows the case where the flow rate of the oxidation gas to be supplied is the largest. The IV characteristics in FIG. 4 are the characteristics in the case where the flow rate of the fuel gas supplied to the fuel cell 100 is excessive with respect to the flow rate of oxidation gas.

As shown in FIG. 4, in the fuel cell 100, as the flow rate of the oxidation gas to be supplied is smaller, the degree of lowering in output voltage with respect to increase in output current becomes larger. Accordingly, it is understood that the value of current that is to be swept from the fuel cell 100 in order to implement a desired refresh voltage V_{R}, that is a reduction voltage during the refresh process, becomes smaller as the flow rate of the oxidation gas to be supplied is smaller. In FIG. 4, the current value for implementing the refresh voltage V_{R} is I1 in the graph C1 where the flow rate of oxidation gas is smaller. In the graph C3 where the flow rate of oxidation gas is larger, it is indicated that the current value for implementing the refresh voltage V_{R} is I2 that is a larger value than I1. In step S140 of the present embodiment, the value of current that is to be swept from the fuel cell 100 in order to implement the desired refresh voltage V_{R} is set with use of the flow rate of the oxidation gas acquired in step S130 and the IV characteristics shown in FIG. 4. In this case, as the residual oxygen amount determined in step S120 is smaller, the current that is to be swept from the fuel cell 100 is set to be smaller.

In FIG. 3, the timing when the intermittent operation mode ends is expressed as time t3. The voltage of the fuel cell 100 at time t3, as shown as a point (a), serves as a voltage Va that is the upper limit of the voltage in the intermittent operation mode. At the time, in step S120, the control unit 200 determines that the residual oxygen amount of the fuel cell 100 is a maximum value. Then, in step S140, the control unit 200 sets, as a value of the current swept at the start of the refresh process, a current IRa that is the largest value with respect to the flow rate of the oxidation gas acquired in step S130. In FIG. 3, broken lines represent an output current and an output voltage of the fuel cell 100 when the refresh process is performed by sweeping the current with the set current value.

Contrary to this, when the voltage of the fuel cell 100 at time t3, that is the timing when the intermittent operation mode ends, is the voltage Vc that is a lower limit of the voltage in the intermittent operation mode as shown as a point (c), the control unit 200 determines in step S120 that the residual oxygen amount of the fuel cell 100 is a minimum value. Then, in step S140, the control unit 200 sets, as a value of the current swept at the start of the refresh process, a current IRc that is a minimum value with respect to the flow rate of the oxidation gas acquired in step S130. In FIG. 3, dashed dotted lines represent an output current and an output voltage of the fuel cell 100 when the refresh process is performed in the case where the voltage of the fuel cell 100 at time t3 is the voltage Vc.

When the voltage of the fuel cell 100 at time t3, that is the timing when the intermittent operation mode ends, is a voltage Vb, as shown as a point (b), that is between the upper limit (Va) and the lower limit (Vc) of the voltage in the intermittent operation mode, the control unit 200 determines in step S120 that the residual oxygen amount of the fuel cell 100 is a value between the maximum value and the minimum value. Then, in step S140, the control unit 200 sets a current IRb that is a middle value between the maximum value and the minimum value with respect to the flow rate of the oxidation gas acquired in step S130, as a value of the current swept at the start of the refresh process. In FIG. 3, solid lines represent an output current and an output voltage of the fuel cell 100 when the refresh process is performed in the case where the voltage of the fuel cell 100 at time t3 is the voltage Vb.

The time of shifting from the intermittent operation mode to the normal operation mode is the time when the flow rate of the oxidation gas supplied to the fuel cell 100 starts to increase, and the fuel cell 100 starts to generate electric power. At the time, the flow rate of the oxidation gas supplied to the fuel cell 100 is lower than that in the normal operation mode where the amount of reactant gas to be supplied is excessive with respect to the target electric power generation amount. In FIG. 3, an arrow indicates the state where an air-flow rate increases rapidly after an instruction for normal operation is input. As a result of such a relatively low flow rate of the oxidation gas to be supplied, the FC voltage when current is swept from the fuel cell 100 at the time of shifting from the intermittent operation mode to the normal operation mode is further influenced by the residual oxygen amount present in the fuel cell 100 at the start of the refresh process as well as by the flow rate of the oxidation gas supplied to the fuel cell 100.

In the present embodiment, a map indicating a correspondence relation among the flow rate of the oxidation gas supplied to the fuel cell 100, the FC voltage at the end of the intermittent operation mode, and the current value for implementing a desired refresh voltage V_{R} is stored in advance in a storage unit in the control unit 200. In step S140, the value of current that is to be swept is set with reference to the map. The map may be prepared using values obtained by an experiment in advance, or may be prepared using the result of a simulation.

After setting the current value in step S140, the control unit 200 drives the DC-DC converter 104 to swept current from the fuel cell 100 with a current value set in step S140, and thereby performs the refresh process (step S150). The control unit 200 then ends the present routine.

FIG. 3 shows the refresh process executed by sweeping the current up to time t4. After the instruction for changing to the normal operation mode is input, the compressor 130 is driven such that the fuel cell 100 can generate target electric power corresponding to the electric power requested from the load. The driving amount of the compressor, which is small immediately after the compressor 130 is driven, gradually increases and soon reaches the target driving amount corresponding to the target electric power. In FIG. 3, two-dot chain lines represent the case where the refresh process is not performed. In this case, the fuel cell 100 generates electric power in accordance with the air-flow rate which increases gradually. The output voltage lowers as the output current of the fuel cell 100 increases. After the refresh process is completed, and forcible current sweep is stopped, control as the normal operation mode is performed for generation of the electric power corresponding to the electric power requested from the load. In FIG. 3, time t5 is the timing when the refresh process is completed, and control as the normal operation mode is started. In the case where the power generation amount of the fuel cell 100 is not sufficient enough to satisfy the electric power requested from the load after the instruction for starting the normal operation mode is input, electric power corresponding to the insufficient portion is supplied from the secondary battery 172.

FIG. 3 shows the case where the current values, set as the values of the current to be swept in the refresh process at the start of the refresh process in step S140, are maintained up to time t4 when the refresh process is completed. However, different configurations may be adopted. As described with reference to FIG. 4, the value of current that is to be swept in order to implement a desired voltage is influenced by the flow rate of oxidation gas. Accordingly, the current value to be swept may be increased in accordance with the increase in flow rate of the oxidation gas after the refresh process is started. For example, when the influence of the residual oxygen amount exerted on the output voltage of the fuel cell 100 gradually decreases after the start of the refresh process, the value of current to be swept may gradually be approximated to a specific value which is determined in accordance with the flow rate of oxidation gas to be supplied, regardless of the residual oxygen amount in step S120. Thus, after the start of the refresh process, the value of current to be swept may properly be corrected from the value set in step S140 such that the output voltage of the fuel cell 100 is maintained at a desired refresh voltage V_{R} as necessary.

The fuel cell system 30 of the present embodiment configured as described above can restrain the FC voltage from deviating and varying from the desired refresh voltage V_{R} when the refresh process is executed. This makes it possible to restrain an excessive reduction of the catalyst of the electrode due to the output voltage being too low at the time of the refresh process. When the excessive reduction of the catalyst is restrained, degradation of the electrode can be restrained, and thereby the durability of the fuel cell 100 can be enhanced. Furthermore, in the present embodiment, the FC voltage can be restrained from deviating and varying from the desired refresh voltage V_{R} when the refresh process is executed. Accordingly, it becomes possible to restrain insufficient recovery of electric power generation performance attributed to the output voltage at the time of the refresh process being too high. Since the electric power generation performance can sufficiently be recovered, the fuel efficiency or the cruising range of the fuel cell vehicle 20 can be enhanced. Furthermore, in the present embodiment, the residual oxygen amount is determined with use of the voltage of the fuel cell 100 at the end of the intermittent operation mode. Accordingly, the necessity of providing a special sensor for acquiring the residual oxygen amount is eliminated, and complication of the system configuration can be restrained.

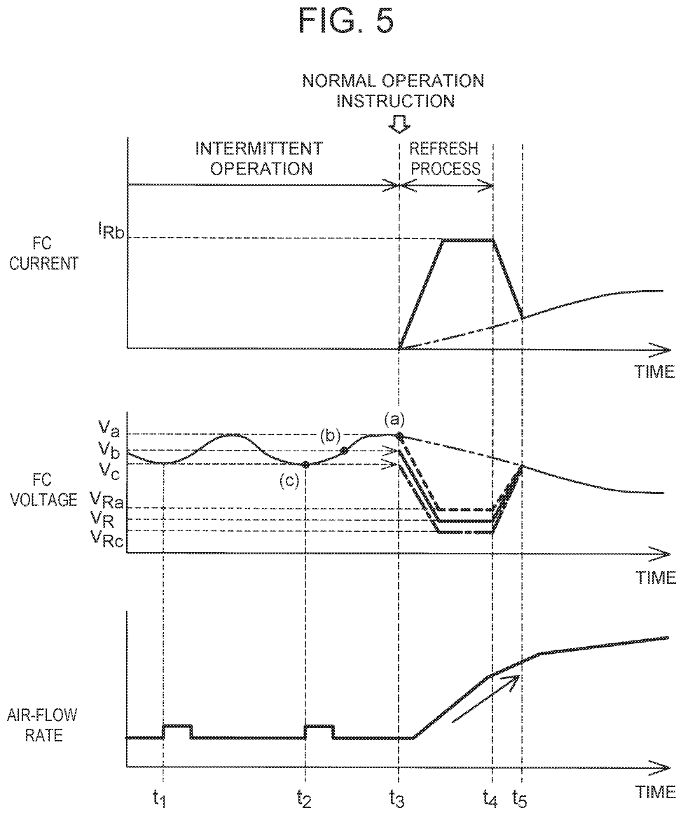

FIG. 5 is an explanatory view showing, as in the case of FIG. 3, a relation between an FC current, an FC voltage, and an air-flow rate before and after the refresh process in the fuel cell system of a comparative example. In the comparative example shown in FIG. 5, the refresh process is performed, as described with reference to FIG. 4, by setting a current value in consideration of only the flow rate of the oxidation gas supplied to the fuel cell without consideration of the residual oxygen amount. In such a case, the FC voltage at the time of the refresh process varies in accordance with the residual oxygen amount at the end of the intermittent operation mode. More specifically, when the voltage of the fuel cell at time t3 when the intermittent operation mode ends is an upper limit voltage Va shown as a point (a), the FC voltage at the time of the refresh process becomes a voltage V_{Ra} that is higher than a desired refresh voltage V_{R}. When the voltage of the fuel cell at time t3 is the lower limit voltage Vc shown as a point (c), the FC voltage at the time of the refresh process becomes a voltage V_{Rc} lower than the desired refresh voltage V_{R}. According to the present embodiment, as the residual oxygen amount is smaller, the current swept from the fuel cell at the start of the refresh process is set to be smaller. This makes it possible to restrain the variation in FC voltage at the time of the refresh processes as described before, and to thereby approximate the FC voltage to a desired refresh voltage V_{R}.

In the present embodiment, the refresh process is executed at timing when the intermittent operation mode ends during a shift from the intermittent operation mode to the normal operation mode. If the refresh process is executed in the normal operation mode, the output voltage of the fuel cell 100 lowers due to the execution of the refresh process, which may cause occurrence of inconvenience such as deteriorated responsiveness to a load request in the normal operation mode. The occurrence of inconvenient such as deteriorated responsiveness can be restrained by executing the refresh process at the timing as in the present embodiment. When the refresh process is executed in the normal operation mode, the flow rate of oxidation gas supplied to the fuel cell 100 is relatively large. Accordingly, as understood from FIG. 4, lowering the FC voltage to a reduction voltage requires sweep of more current and generation of more electric power at the time of the refresh process. When the refresh process is executed at the timing as in the present embodiment, the value of current swept at the time of the refresh process can be kept low, and hydrogen consumption relating to electric power generation at the time of the refresh process can be reduced.

In the intermittent operation mode, the flow rate of the oxidation gas supplied to the fuel cell 100 is zero or extremely small. Accordingly, if the refresh process is executed in the intermittent operation mode, it may cause inconvenience such as special control becoming necessary for supplying oxidation gas for the refresh process, or the responsiveness being deteriorated in the case of shifting to the normal operation mode after the refresh process. The occurrence of such inconvenience can be restrained by executing the refresh process at the timing as in the present embodiment.

### B. Second Embodiment

In the first embodiment, as the voltage of the fuel cell 100 at the end of the intermittent operation mode is lower, the residual oxygen amount of the fuel cell 100 is determined to be smaller in step 120. However, different configurations may be adopted. For example, the residual oxygen amount may be determined smaller, as a difference between a maximum value and a minimum value of respective voltages of a plurality of single cells which configure the fuel cell 100 at the end of the intermittent operation mode is larger. The cell monitor 106 shown in FIG. 1 detects the voltage of each of the single cells which configure the fuel cell 100.

As the residual oxygen amount is smaller, i.e., as the amount of oxidation gas present in the fuel cell 100 is smaller, distribution variation of oxidation gas among the single cells tends to become larger, and a difference in residual oxygen amount in every single cell becomes larger. At the end of the intermittent operation mode, the single cells having more oxidation gas therein have a higher single cell voltage, whereas the single cells having less oxidation gas therein have a lower single cell voltage. Accordingly, as the residual oxygen amount in the fuel cell 100 is smaller, a difference between the maximum value and the minimum value of the respective voltages of the plurality of single cells which configure the fuel cell 100 becomes larger. Hence, the above-described determination method becomes adoptable.

In the second embodiment, a map indicating a correspondence relation among a flow rate of oxidation gas supplied to the fuel cell 100, a difference between the maximum value and the minimum value of respective voltages of the single cells at the end of the intermittent operation mode, and a current value for implementing a desired refresh voltage V_{R} may be stored in the storage unit of the control unit 200 in advance. In step S140, a value of current that is to be swept may be set with reference to the map. In this case, the same effect as the first embodiment can also be obtained.

### C. Third Embodiment

In another method of determining the residual oxygen amount in the fuel cell 100, the residual oxygen amount may be determined to be smaller, as a minimum value of respective voltages of a plurality of single cells which configure the fuel cell 100 at the end of the intermittent operation mode is smaller. As described in the first embodiment, the FC voltage at the end of the intermittent operation mode becomes lower, as the residual oxygen amount is smaller. As described in the second embodiment, variation in voltage of the single cells becomes larger, as the residual oxygen amount is smaller. Accordingly, the residual oxygen amount can be determined to be smaller, as the minimum value of respective voltages of the single cells is smaller.

### D. Fourth Embodiment

In another method of determining the residual oxygen amount in the fuel cell 100, an oxygen concentration sensor capable of detecting an oxygen partial pressure in the cathode-side passage of the fuel cell 100 may be provided in the fuel cell 100. Such configuration makes it possible to directly detect and determine the residual oxygen amount.

### E. Other Embodiments

E1

In each of the above embodiments, the fuel cell 100 stops electric power generation in the intermittent operation mode. However, different configurations may be adopted. More specifically, in a low load state where the electric power requested from the load is a preset reference value or less, minute electric power may be generated in the fuel cell 100, while the output voltage of the fuel cell 100 is maintained in the range where degradation of the electrode catalyst can be restrained. Thus, in the case where the residual oxygen amount varies at the time of the intermittent operation mode even when the fuel cell 100 generates electric power in the intermittent operation mode, a value of current swept at the start of the refresh process may be set by using the residual oxygen amount at the end of the intermittent operation mode as in each of the embodiments. This makes it possible to achieve the same effect that is to restrain the variation in output voltage at the time of the refresh process and to thereby approximate the output voltage to a desired refresh voltage V_{R}.

E2

In each of the embodiments, the fuel cell system 30 is used as a power source for driving a vehicle. However, different configurations may be adopted. For example, the fuel cell system 30 may also be used as a power source for driving mobile objects other than the vehicle, and may also be used as a stationary power source.

Without being limited to the aforementioned embodiments, the present disclosure can be implemented in various configurations without departing from the meaning thereof. For example, technical features in the embodiments corresponding to the technical features in each aspect described in SUMMARY can be replaced or combined as appropriate in order to solve some or all of the aforementioned problems, or in order to accomplish some or all of the aforementioned effects. The technical features may be deleted as appropriate unless the technical features are described as essential in the specification.

What is claimed is:

1. A fuel cell system, comprising:
a fuel cell formed of a stack of a plurality of single cells, the fuel cell being configured to supply electric power to a load upon receiving supply of an oxidation gas containing oxygen and a fuel gas containing hydrogen;
an oxidation gas supply unit configured to supply the oxidation gas to the fuel cell;
a control unit configured to control an operating state of the fuel cell system; and
a determination unit configured to determine an oxygen amount in the fuel cell, wherein:
when electric power requested from the load exceeds a predetermined reference value, the control unit controls the operating state of the fuel cell system so as to enable a normal operation mode where the fuel cell generates electric power corresponding to the requested electric power;
when the requested electric power becomes the reference value or less, the control unit controls the operating state of the fuel cell system so as to enable an intermittent operation mode where the oxidation gas supply unit supplies to the fuel cell an oxygen amount that is required to adjust the voltage of the fuel cell to a preset target voltage, the oxygen amount being smaller than the oxygen amount supplied to the fuel cell in the normal operation mode;
the control unit executes a refresh process for sweeping current from the fuel cell and thereby lowering the voltage of the fuel cell to a reduction voltage at timing when the intermittent operation mode ends during a shift from the intermittent operation mode to the normal operation mode; and
the control unit sets a value of the current swept from the fuel cell at a start of the refresh process to be lower, as the oxygen amount determined by the determination unit at the timing is smaller.

2. The fuel cell system according to claim 1, wherein the determination unit determines that the oxygen amount in the fuel cell is smaller as the voltage of the fuel cell at the timing is lower.

3. The fuel cell system according to claim 1, wherein the determination unit determines that the oxygen amount in the fuel cell is smaller as a difference between a maximum value and a minimum value of respective voltages of the plurality of single cells that configure the fuel cell at the timing is larger.

4. The fuel cell system according to claim 1, wherein the determination unit determines that the oxygen amount in the fuel cell is smaller as a minimum value of respective voltages of the plurality of single cells that configure the fuel cell at the timing is smaller.

5. A control method of a fuel cell system, the fuel cell system including a fuel cell that is configured to supply electric power to a load upon receiving supply of an oxidation gas containing oxygen and a fuel gas containing hydrogen, the method comprising:
controlling, when electric power requested from the load exceeds a predetermined reference value, an operating state of the fuel cell system so as to enable a normal operation mode where the fuel cell generates electric power corresponding to the requested electric power;
controlling, when the requested electric power becomes the reference value or less, the operating state of the fuel cell system so as to enable an intermittent operation mode where an oxygen amount that is required to adjust the voltage of the fuel cell to a preset target voltage is supplied to the fuel cell, the oxygen amount being smaller than the oxygen amount supplied to the fuel cell in the normal operation mode;
determining, during a shift of the operating mode of the fuel cell from the intermittent operation mode to the normal operation mode, the oxygen amount in the fuel cell at an end of the intermittent operation mode; and
executing, at timing when the intermittent operation mode ends during the shift, a refresh process for sweeping current from the fuel cell and lowering the voltage of the fuel cell to a reduction voltage, wherein
as the oxygen amount determined at the timing is smaller, a value of the current swept from the fuel cell at a start of the refresh process is set to be lower.
